(19) United States
(12) Patent Application Publication
(10) Pub. No.: US 2001/0006467 A1
(43) Pub. Date: Jul. 5, 2001

(54) Motor vehicle headlight with selective specialisation

(76) Inventor: Norbert Brun, Bobigny (FR)

Correspondence Address: Joseph A. Calvaruso, Esq, Morgan & Finnegan, L.L.P, 345 Park Avenue, New York, NY, 10154-0053, US

(21) Appl. No.: 09/742,969

(22) Filed: Dec. 20, 2000

(30) Foreign Application Priority Data
Dec. 23, 1999 (FR) 99 16374

(51) Int. Cl. B60Q 1/04

(52) U.S. Cl. 362/512; 362/521

(57) ABSTRACT

A motor-vehicle headlight has a light source interacting with a mirror to generate a lighting beam. Interposed on the path of a part of the radiation leaving the mirror, is an optical assembly with first and second deflecting optical elements taking up a first mutual position in which they are successively traversed by the said part of the radiation, and a second mutual position in which they are each traversed by two separate parts of the radiation, so as selectively to obtain two light beams with different photometry aspects.

### FIELD OF THE INVENTION

The present invention relates in a general way to the headlights of motor vehicles.

### BACKGROUND OF THE INVENTION

The tendency at the present time is to enhance the quality of the lighting from headlights according to circumstances (specialised or “intelligent” lighting).

For example, outside of the traditional functions of cruise lighting (dipped) or of main-beam lighting, it is sought, without multiplying the number of headlights at the front of the vehicle, to produce light beams called turning beams, where the dipped or main beam is enhanced in the lateral direction towards the inside of a turn made by the vehicle, light beams called motorway light beams, with photometry midway between that of a dipped beam and that of a main beam, beams with variable width, for example on the basis of the speed at which the vehicle is travelling, etc.

The object of the present invention is to produce a headlight, in this context, in which a “nominal” beam can be modified or specialised on demand, so as to adapt it to particular driving conditions, without multiplying the number of headlights and without unduly complicating a standard headlight or making it more expensive.

### SUMMARY OF THE INVENTION

According to the present invention there is provided a motor-vehicle headlight, comprising a light source interacting with a mirror in order to generate a lighting beam, and further comprising, interposed on the path of a part of the radiation leaving the mirror, an optical assembly possessing first and second deflecting optical elements selectively able to take up a first mutual position in which they are successively traversed by the said part of the radiation, and a second mutual position in which they are each traversed by two separate parts of the radiation, so as selectively to obtain two light beams with different photometry aspects.

Preferred, but non-limiting, aspects of the headlight according to the invention are as follows:

in their first mutual position, the two optical elements are essentially neutral as regards the said part of the radiation,

the innermost optical element possesses a planar entry face,

the said entry face is generally perpendicular to an optical axis of the mirror,

the outermost optical element possesses a planar exit face,

the said exit face is generally perpendicular to an optical axis of the mirror,

the innermost optical element possesses an exit face in the shape of a cylindrical portion with a vertical generatrix,

the said exit face is convex,

the said cylindrical portion belongs to an axisymmetric cylinder.

the axis of the said axisymmetric cylinder is approximately centred on the optical element in the direction of its width,

the outermost optical element possesses an entry face in the shape of a cylindrical portion with vertical generatrix,

the said entry face is concave,

the said cylindrical portion belongs to an axisymmetric cylinder,

the axis of the said axisymmetric cylinder is approximately centred on the optical element in the direction of its width,

the exit face of the inner element and the entry face of the outer element extend, in the first position of the optical assembly, along one another,

the mutual shifting of the two elements is carried out in a direction parallel to the generatrices of the exit face of the inner element and of the entry face of the outer element,

at least one of the optical elements, in the second position of the optical assembly, produces an average deflection of the light which is not zero in the lateral direction,

in the said second position of the optical assembly, the two optical elements produce non-zero average deflections in the two opposite lateral directions,

the said cylindrical portions exhibit sections in the shape of circular arcs the chords of which are not perpendicular to an optical axis of the mirror,

the two optical elements are able to take up at least one third mutual position midway between the first mutual position and the second mutual position,

the two optical elements are able to be shifted progressively with respect to one another between the first and second mutual positions,

the optical assembly is situated in line with a region of the mirror generating essentially parallel radiation,

the optical assembly is situated in line with a region of the mirror generating radiation which is essentially parallel to an optical axis of the mirror,

the optical assembly is situated in line with the central region of an upper part of the mirror,

the mutual shifting of the optical elements is carried out in a generally vertical direction,

in the first mutual position of the two optical elements, the contours of the first and second elements are essentially coincident.

### BRIEF DESCRIPTION OF THE DRAWINGS

Other aspects, objects and advantages of the present invention will emerge better on reading the following detailed description of preferred embodiments thereof, given by way of non-limiting example and by reference to the attached drawings, in which:

FIGS. 1a and 1b are diagrammatic and partial views in perspective of a headlight according to a first embodiment of the invention, in two different states,

FIGS. 2a and 2b are front views of the headlight represented in FIGS. 1a and 1b,

FIGS. 3a and 3b are top views of the headlight represented in FIGS. 1a and 2b, and

FIGS. 4a and 4b are partial top views of a variant embodiment of the invention.

### DESCRIPTION OF THE PREFERRED EMBODIMENTS

In the various figures, like reference numerals refer to like parts.

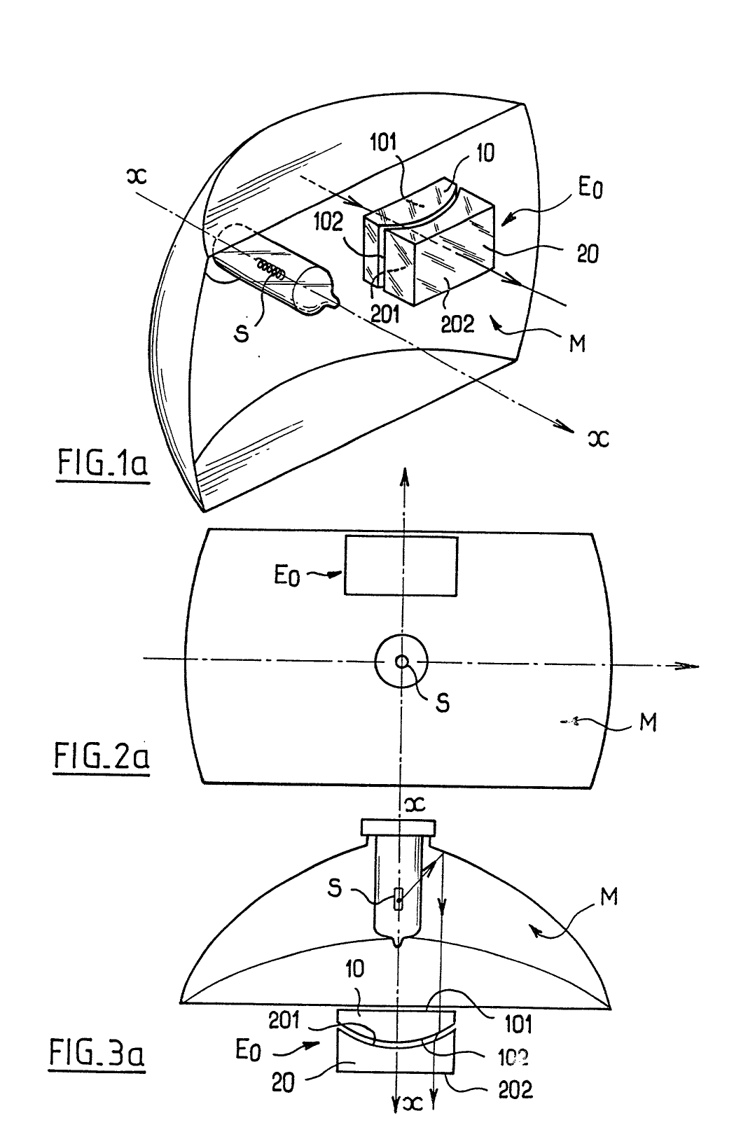

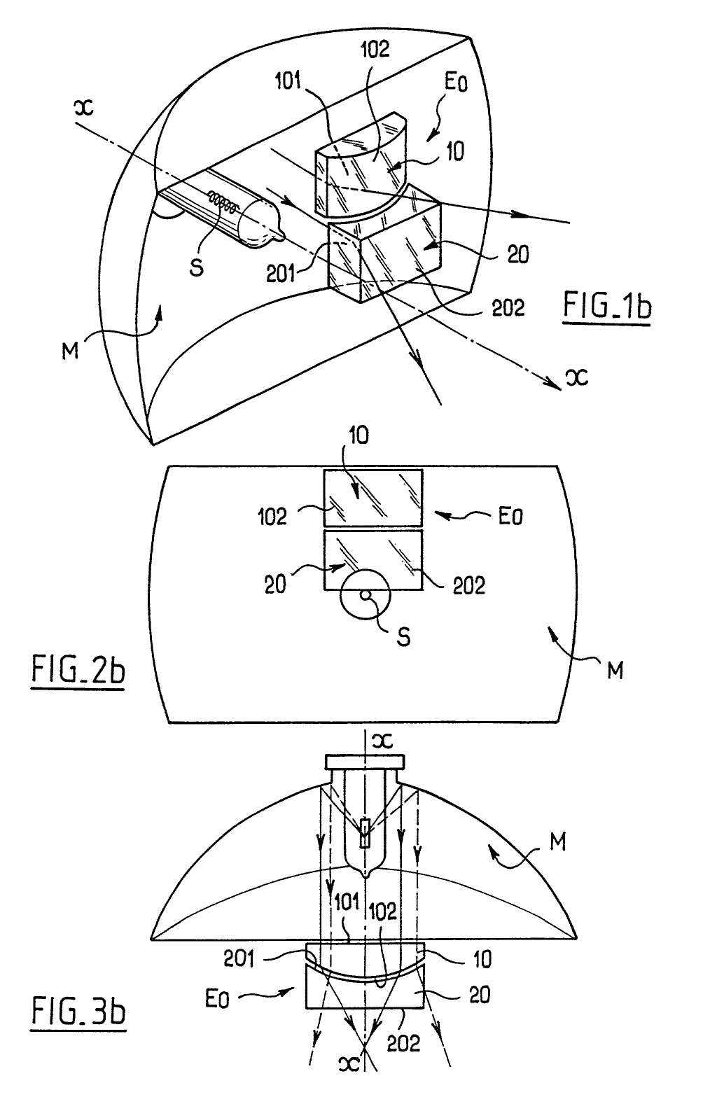

With reference to FIGS. 1a, 1b, 2a, 2b, 3a and 3b, a headlight has been represented diagrammatically which comprises a light source S, such as the filament of an incandescent lamp or the luminescent arc of a discharge lamp, which interacts with a mirror M to generate a light beam. This headlight also includes glazing, not represented, as well as all the usual ancillary equipment.

In line with a defined part of the mirror, and, in the present example, with the region of the middle of the upper part of the mirror, an optical assembly is provided for modifying the beam EO, which consists of two transparent elements 10 and 20, which here, in front view (FIGS. 2a and 2b) exhibit the same rectangular contour.

The inner element 10 is linked to a fixed support (not represented). The outer element 20 for its part is linked to a moveable support (not represented) so as to be able to be shifted selectively in the vertical direction between a first position or high position, as illustrated in FIGS. 1a, 2a and 3a, in which it is in line with the element 10, and a second position, or low position, in which, in the front view of FIG. 2b, it is located immediately below the element 10.

The support of the moveable element 20 can be shifted, for example, by an electromagnet controlled from the passenger compartment of the vehicle, or automatically on the basis of sensors representative of the driving conditions.

The element 10 possesses a planar entry face 101 generally perpendicular to the optical axis xx of the mirror M, and a convex exit face 102 in the shape of an axisymmetric cylindrical portion with vertical axis. It thus constitutes a plane-convex cylindrical lens. The axis of the said axisymmetric cylinder is here approximately centred on the optical element in the direction of its width, the element thus being generally symmetric with respect to its median vertical plane.

The element 20 for its part possesses a concave cylindrical entry face 201 which, in the position of FIGS. 1a, 2a and 3a, substantially matches the shape of the exit face of the element 10, and a planar exit face 202 which is generally perpendicular to the abovementioned optical axis xx.

In the position represented in FIGS. 1a, 2a and 3a, it will be understood that the two optical elements cancel each other out, as regards incident radiation essentially parallel to the optical axis xx, so as to leave this radiation substantially unaltered. More precisely, the exit face 102 and the entry face 201 delimit a curved air gap of substantially constant thickness, which creates substantially no deflection of the radiation, only a slight lateral offset of certain rays being observed, which is of no significance as to the overall photometry of the beam.

Hence it will be understood that the beam generated by the headlight in this situation is the same beam which is generated by the interaction between the source S and the mirror M, disregarding any deflection arrangements formed on the glazing.

In particular, if the optical assembly receives radiation generally parallel to the optical axis xx, this radiation will retain this parallelism upon exit from the optical element and contribute, in the beam, to a central concentration spot of the said beam.

If the two optical elements 10 and 20 are now offset with respect to one another so as to reach the situation illustrated in FIGS. 1b, 2b and 3b, then it will be understood that the optical elements cease to cancel each other out; the inner element 10 then behaves as an element which, in vertical projection onto a horizontal plane, causes the light to converge as illustrated in FIG. 3b (light rays in solid lines), and after having crossed the convergence region, the radiation diverges so as to obtain a light-beam part widened in the lateral direction.

Likewise, the optical element 20 behaves as an element which, in vertical projection onto a horizontal plane, causes the light to diverge directly (see light rays illustrated in dashed line in FIG. 3b), in order, here again, to obtain a beam part widened in the lateral direction.

Hence, by virtue of the optical assembly described above, it is possible selectively to obtain either a beam exhibiting a given light concentration in the axis of the road, or a beam in which at least a part of the light previously contributing to this concentration has been spread laterally in order now to contribute to the width of the beam.

For example, the first position may be adopted for traffic moving in a straight line and/or at high speed, while the second position may be adopted for traffic on a bend and/or at lower speed.

The second position can also be used in foggy conditions.

According to one variant of this embodiment, a progressive shifting of the optical elements with respect to one another can be implemented, so as progressively to diminish the central concentration in favour of the width.

According to yet another variant, provision can be made for each element 10, 20 to be moveable, one upwards and the other downwards, each over a distance substantially equal to half of the height of the elements 10, 20.

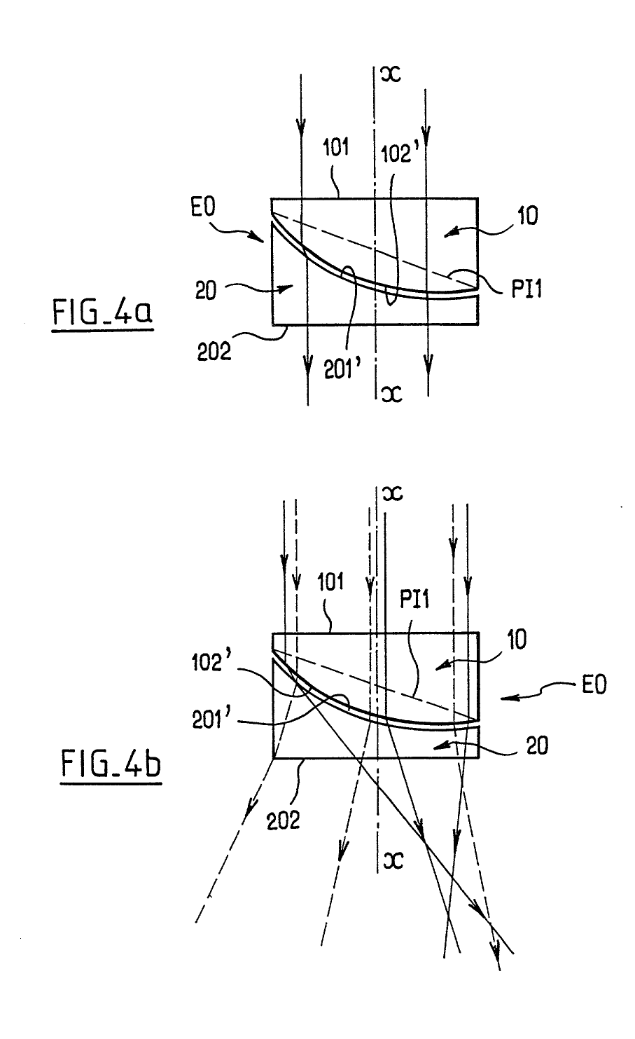

By reference now to FIGS. 4a and 4b, a variant of the optical assembly of the preceding figures has been represented.

According to this variant, the exit face 102′ from the inner element 10 consists of a piece of convex cylinder the circular section of which exhibits the shape of a circular arc, including the chord PI1 which is not perpendicular to the optical axis x-x of the headlight. Likewise, the entry face 201′ of the element 20 consists of a concave cylinder which, at a slight distance, matches the convex cylinder of the first element, with a chord of arc parallel to the abovementioned chord PI1.

In the position in which the elements 10 and 20 are situated in line with one another (FIG. 4a), they cancel out as before, so as to leave the beam part in question essentially intact.

In the position in which the elements 10 and 20 are offset in height (FIG. 4b), they each behave like the combination of a prism and of a cylindrical lens. More precisely, the inner element 10 possesses a prismatic effect which will give rise to an average deflection of the light laterally towards the left at the front of the vehicle (towards the right in FIG. 4b), this light moreover being spread by virtue of the convexity of the exit face 102′.

Conversely, the outer element 20 possesses a prismatic effect which will give rise to an average deflection of the light towards the right at the front of the vehicle (towards the left in FIG. 4b), substantially with the same degree of deflection as that achieved by the inner element 10, and the concave cylindrical entry face will cause a spreading of this light.

It will be understood that this variant of the invention makes it possible to reinforce the beam laterally to left and to right more strongly than in the case of the preceding embodiment, since, in this case, the light processed by the two offset elements 10, 20 contributes to the beam only in the lateral regions thereof, but not in its central region.

Clearly, here again, a progressive offsetting of the optical elements with respect to one another can be provided for.

The present invention is not in any way limited to the embodiments described and represented, but the person skilled in the art will be able to apply numerous variants or modifications to it.

In particular, although in the preceding description the two optical elements situated in line with one another cancel each other out, it can be arranged, when the two optical elements are situated in line with one another, that they jointly cause a certain predetermined deflection processing of the light participating in the beam.

What we claim is:

1. Motor-vehicle headlight, comprising a light source interacting with a mirror in order to generate a lighting beam, and further comprising, interposed on the path of a part of the radiation leaving the mirror, an optical assembly possessing first and second deflecting optical elements selectively able to take up a first mutual position in which they are successively traversed by the said part of the radiation, and a second mutual position in which they are each traversed by two separate parts of the radiation, so as selectively to obtain two light beams with different photometry aspects.

2. The headlight of claim 1, wherein, in their first mutual position, the two optical elements are essentially neutral as regards the said part of the radiation.

3. The headlight of claim 1, wherein the innermost optical element possesses a planar entry face.

4. The headlight of claim 3, wherein the said entry face is generally perpendicular to an optical axis of the mirror.

5. The headlight of claim 1, wherein the outermost optical element possesses a planar exit face.

6. The headlight of claim 5, characterised in that the said exit face is generally perpendicular to an optical axis of the mirror.

7. The headlight of claim 1, wherein the innermost optical element possesses an exit face in the shape of a cylindrical portion with a vertical generatrix.

8. The headlight of claim 7, wherein the said exit face is convex.

9. The headlight of claim 7, wherein the said cylindrical portion belongs to an axisymmetric cylinder.

10. The headlight of claim 9, wherein the axis of the said axisymmetric cylinder is approximately centred on the optical element in the direction of its width.

11. The headlight of claim 1, wherein the outermost optical element possesses an entry face in the shape of a cylindrical portion with vertical generatrix.

12. The headlight of claim 11, wherein the said entry face is concave.

13. The headlight of claim 12, wherein the said cylindrical portion belongs to an axisymmetric cylinder.

14. The headlight of claim 13, wherein the axis of the said axisymmetric cylinder is approximately centred on the optical element in the direction of its width.

15. The headlight of claim 1, wherein the innermost optical element possesses an exit face in the shape of a cylindrical portion with a vertical generatrix, wherein the outermost optical element possesses an entry face in the shape of a cylindrical portion with vertical generatrix, and wherein the exit face of the inner element and the entry face of the outer element extend, in the first position of the optical assembly, along one another.

16. The headlight of claim 15, wherein the mutual shifting of the two elements is carried out in a direction parallel to the generatrices of the exit face of the inner element and of the entry face of the outer element.

17. The headlight of claim 1, wherein at least one of the optical elements, in the second position of the optical assembly, produces an average deflection of the light which is not zero in the lateral direction.

18. The headlight of claim 17, wherein, in the said second position of the optical assembly, the two optical elements produce non-zero average deflections in the two opposite lateral directions.

19. The headlight of claim 18 wherein the innermost optical element possesses an exit face in the shape of a cylindrical portion with a vertical generatrix, wherein the outermost optical element possesses an entry face in the shape of a cylindrical portion with vertical generatrix and wherein the said cylindrical portions exhibit sections in the shape of circular arcs the chords of which are not perpendicular to an optical axis of the mirror.

20. The headlight of claim 18 wherein the innermost optical element possesses an exit face in the shape of a cylindrical portion with a vertical generatrix, wherein the outermost optical element possesses an entry face in the shape of a cylindrical portion with vertical generatrix, and wherein the exit face of the inner element and the entry face of the outer element extend, in the first position of the optical assembly, along one another, wherein the said cylindrical portions exhibit sections in the shape of circular arcs the chords of which are not perpendicular to an optical axis of the mirror.

21. The headlight of claim 1, wherein the two optical elements are able to take up at least one third mutual position midway between the first mutual position and the second mutual position.

22. The headlight of claim 21, wherein the two optical elements are able to be shifted progressively with respect to one another between the first and second mutual positions.

23. The headlight of claim 1, wherein the optical assembly is situated in line with a region of the mirror generating essentially parallel radiation.

24. The headlight of claim 1, wherein the optical assembly is situated in line with a region of the mirror generating radiation which is essentially parallel to an optical axis of the mirror.

25. The headlight of claim 1, wherein the optical assembly is situated in line with the central region of an upper part of the mirror.

26. The headlight of claim 1, wherein the mutual shifting of the optical elements is carried out in a generally vertical direction.

27. The headlight of claim 1, wherein, in the first mutual position of the two optical elements, the contours of the first and second elements are essentially coincident.
